(19) United States
(12) Patent Application Publication
(10) Pub. No.: US 2011/0173099 A1
(43) Pub. Date: Jul. 14, 2011

(54) METHOD AND DATA PROCESSING SYSTEM FOR TRANSPORT SERVICE PROVIDERS

(75) Inventors: Dirk Jantsch, Koln (DE); Hans-Joachim Von-Bremen, Marsberg-Westheim (DE)

(73) Assignee: WINCOR NIXDORF INTERNATIONAL GMBH, Paderborn (DE)

(21) Appl. No.: 13/061,818

(22) PCT Filed: Sep. 2, 2009
(86) PCT No.: PCT/EP2009/061317

§ 371 Date: Mar. 2, 2011

(30) Foreign Application Priority Data
Sep. 5, 2008 (EP) 08163751.4

(51) Int. Cl. G06Q 30/00

(52) U.S. Cl. 705/27.1

(57) ABSTRACT

Device for variably depicting postal services for postal products comprising:
a processor that performs calculations and interprets formulas at runtime
with a database system that
   a) has a destination table in which the possible destinations for the postal product are stored;
   b) a table for the postal product in which the possible types of postal product are stored;
   c) a table for additional services in which the type of transport of the postal product is stored;
   d) a table with price information, wherein tables a)-d) are directly or indirectly linked by additional tables, wherein at least one database field is provided in which formulas are stored that can be changed by a user and which are interpreted at runtime by the processor to calculate the price;
with a network interface to allow communication with clients over a network, wherein inquiries about pricing are received over the interface and which makes it possible to receive all the required information for pricing or only parts to begin a dialog with the client if information is missing.

### CROSS-REFERENCE TO RELATED APPLICATIONS

This application is a National Stage of International Application No. PCT/EP2009/061317, filed Sep. 2, 2009. This application claims the benefit and priority of German application EP 08163751.4 filed Sep. 5, 2008. The entire disclosures of the above applications are incorporated herein by reference.

### BACKGROUND

This section provides background information related to the present disclosure which is not necessarily prior art.

The invention relates to a method and a device for the automated, flexible configuration and depiction of the product structure of postal/transport products that permits a simple and flexible use among different transport service providers.

### TECHNICAL FIELD

Many control systems have been designed for only one postal service provider, e.g. UPS, TNT, the Royal Mail, DPD, etc. and developed for their needs. Our objective is to provide the most flexible possible system that meets the requirements of all service providers and makes their products effectively recognizable. To do this, it is necessary to choose a system architecture that makes it possible to store a plurality of products flexibly in this system in order to carry out calculations with them.

### SUMMARY OF THE INVENTION

The preferred embodiment is concerned with a server system that includes an SOA—service oriented architecture. In an architecture of this type, specific interfaces are provided. Even if there is no generally accepted definition of SOA, the definition by OASIS from 2006 is frequently quoted:

“SOA is a paradigm for the structuring and use of distributed capabilities that are under the control of various ownerships.”

The central topic of all definitions is the services. The following enumerates the ideal properties of services in an SOA. In practice, not all of the requirements are met completely. The features of the service are defined as follows.
A service is self-contained and can be used independently.
A service is available on a network.
A service has a published interface. It is sufficient to know this interface to use it. Knowledge about the details of how it is used is not required.
A service is independent of a platform, i.e. providers and users of a service can be implemented in different programming languages and on different platforms.
A service is registered in a directory.
A service is dynamically connected, i.e. when an application is created that uses a service the service need not exist. It is only localized and integrated when it is run.

Services are usually by carried out by XML commands. Alternative formats are available of course.

The server system has one or several processors by which the calculations are performed, that control a database and assume additional tasks that the processors receive from the operating system. In addition, at runtime, formulas are interpreted. This can be done by an embedded formula interpreter or by using a code that allows it to be employed as a database trigger or by using JAVA, C# or other interpreter languages.

There is in addition access to a database system that is managed on the same server system or on an additional server system.

The database comprises:
a) A table for the destination in which the potential destinations for the postal product are stored. This table is preferably linked to a series of further tables that administer the country and the zip codes. This makes it possible to determine the destination for a product. The destination stands in relation to the additional services, products and fees.
b) The database further comprises a table for the postal product in which the possible types of postal product are stored. For example, letters or packages in different sizes can be listed there as postal products. This table is also preferably linked to other tables
c) The database further comprises a table for the additional service in which the type of transport for the postal product is stored. The type of transport can be, for example, the amount of insurance, the speed of transportation, COD charges, etc.
d) The database further comprises a table with information regarding prices, in which the prices for products in relation to the additional services are listed.

All the tables are linked to each other directly or indirectly through additional tables to show the products of the particular postal service provider.

The structure of the tables is preferably static. Since some fees are dependent on formulae however, such as the volume weight in the case of air freight, at least one database field is provided in which formulas are saved that can be modified by a user and are interpreted by the processor at runtime to calculate the price. One such field is stored in the Units table which will be discussed later.

Since the device is configured preferably as a service, it needs a communication protocol. This preferably configured in XML. The user of the service has the opportunity of transmitting all information to the service, to the extent he knows it, or only parts. If he transmits only parts, such as destination and product, for example, and does not specify the additional service, the network interface subsequently asks for additional parameters. This can be the additional service, for example. An explanatory text is preferably sent with the particular parameters. An answer of this kind is conceivable

<MISSING_PARAMETER> <AddOnService><AddonServiceDescription>

Information is missing about possible additional services<

/AddonServiceDescription><AddonServiceClasses>COD, Express

delivery, Amount of insurance,
None></AddonServiceClasses></AddonServiceDescription></AddOnService.

Using this type of communication, the client computer that is in contact with the service can recognize that information for the additional services is missing. Now a decision can be made based on the possible AddonServiceClasses which additional service is to be requested or even if an additional service is to be used at all.

The table of add-on services has a sub-table that defines further additional services that can be selected in addition to the existing additional services. Tables are also permitted that define exclusions to the additional services.

Additional tables of exclusions and what is permitted for the destination are linked to tables of products and additional services to show which type of product can be sent to which destination using which service and which cannot.

A unit of a product is further defined by a sub-table. The “unit” table contains the user-defined formula that preferably addresses dimensions and weight. The density can be calculated using this table. The unit can determined as a function of the total weight or ranges. The quantity is further addressed in the Unit table. Quantity can in turn comprise the following: a) number, for example of letters, packages; b) time (quantity) as a number of days, weeks or months in conjunction with poste restante or forwarding mail. c) Value (quantity) in conjunction with completing insurance in the event of loss or damage to the item mailed.

Using this approach, the present invention has a number of technical advantages. As the result of the unified data structure for many postal service providers and the configuration of the system only through the database entries, an update can be developed for all users without having to take individual programming into account. Through the database model, changes can be made considerably more quickly in comparison with traditional, proprietary control systems. An increase in efficiency of more than 50% can be achieved in programming costs, testing costs, logistics costs (sending program program updates). Considerable costs benefits accrue and also platform independence. Basically the database system can operate on a plurality of operating systems so that proprietary solutions that are tailored to specific operating systems can be replaced more easily.

### BRIEF DESCRIPTION OF THE DRAWINGS

The figures will be described briefly in what follows:

FIG. 1 shows a layer model of the present invention;

FIGS. 2-18 show the detailed structure of the tables in the database;

FIGS. 18a-18b show a table with reference to a concrete example;

FIGS. 19-23 show the detailed structure of the tables in the database;

FIG. 24-27 show the relation model of the database.

The drawings described herein are for illustrative purposes only of selected embodiments and not all possible implementations, and are not intended to limit the scope of the present disclosure.

### DETAILED DESCRIPTION OF THE PREFERRED EMBODIMENTS

Example embodiments will now be described more fully with reference to the accompanying drawings.

Since the main entity zone is almost independent of the other main entities, the description begins with the table zone. Then the product will be described that is dependent on the zone and finally the additional service. The tables are classified as described in the Figures.

The syntax of the tables is to be understood as follows: tables that are only images of an ID on a text are identified with ID2Text.

Tables that contain substantially text are marked as Text.

Tables that are relevant to pricing are marked with a P-.

All P-tables contain time information that determines the validity of the entry and that is known from the POSIdentity table:

szDateValidFrom, szTimeValidFrom, szDateValidTo, szTimeValidTo

The tables in the Figures contain the table name as the description of the figure, as columns the column name, the type of data and the description of the field.

A -> table.column shows the reference to another table.

In general the naming conventions are for types

Boolean starts with “b”

Integer starts with “I”

Decimals starts with “d”

Strings start with “sz”

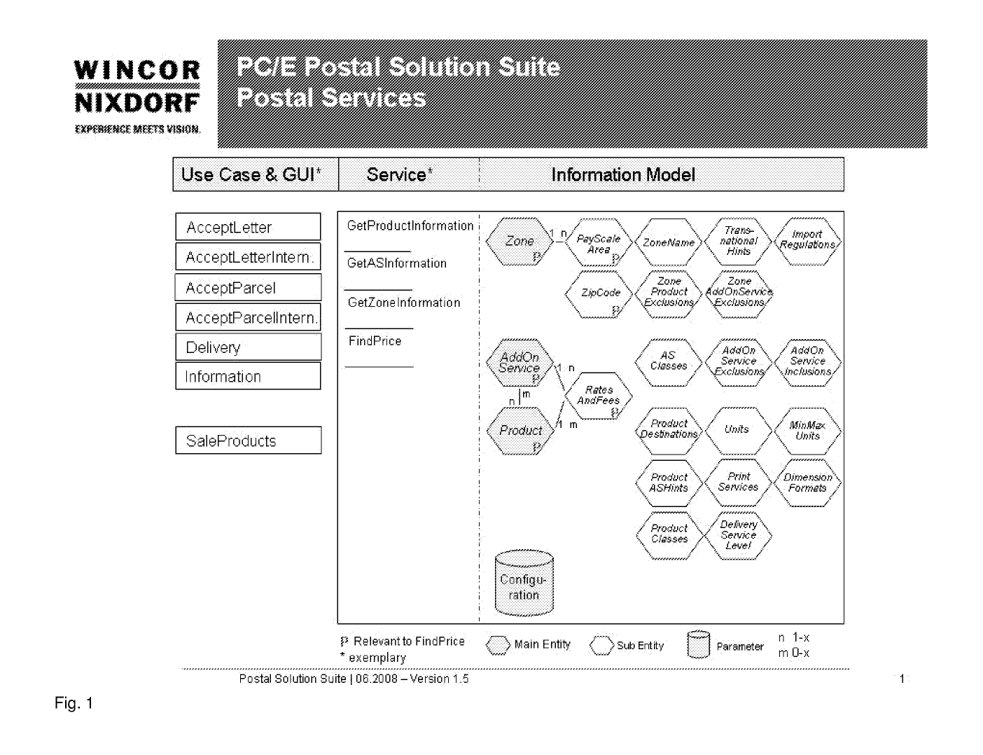

In detail, FIG. 1 shows the structure of the invention. Service is an area that refers back to an information model. The information model is configured as a database. Users and clients use the service and send it product information, information about the area and additional service information. The price is then set by the system as a result.

The database is one of the essential components of the present invention. The tables relating to the area are described as “zone”, the tables relating to product are described as “product,” and the additional services are shown as “AddOnService”. There are other configuration parameters that are kept in a corresponding table. The main tables, as described in the claims, are linked to each other by additional sub-tables, or the features of the main tables are defined in detail by the sub-tables.

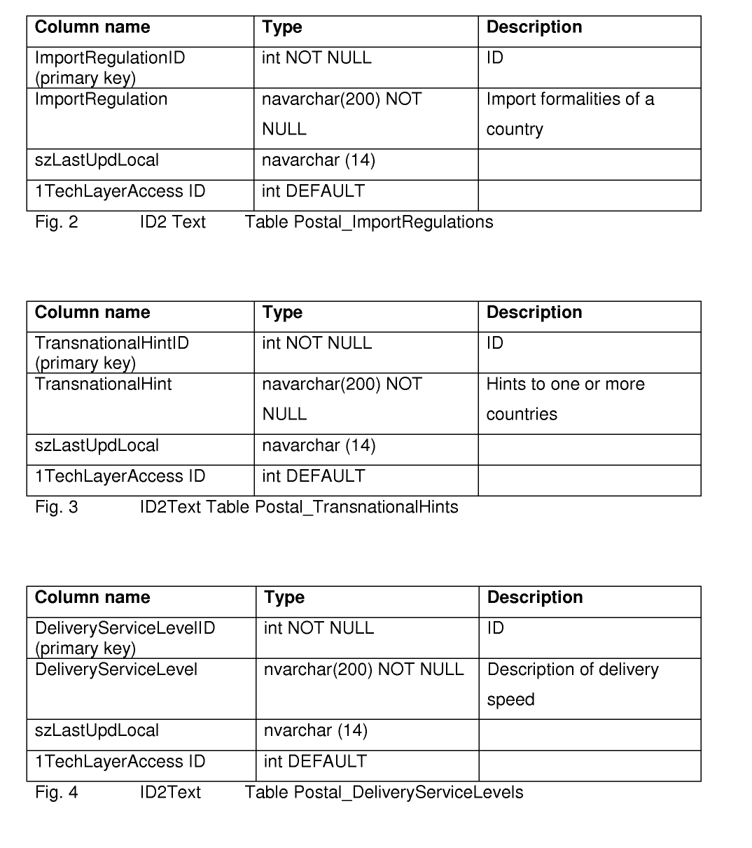

On the basis of the description of the table entries in the Figures, it is often not necessary to explain them in detail. FIGS. 1 to 4 are self-explanatory.

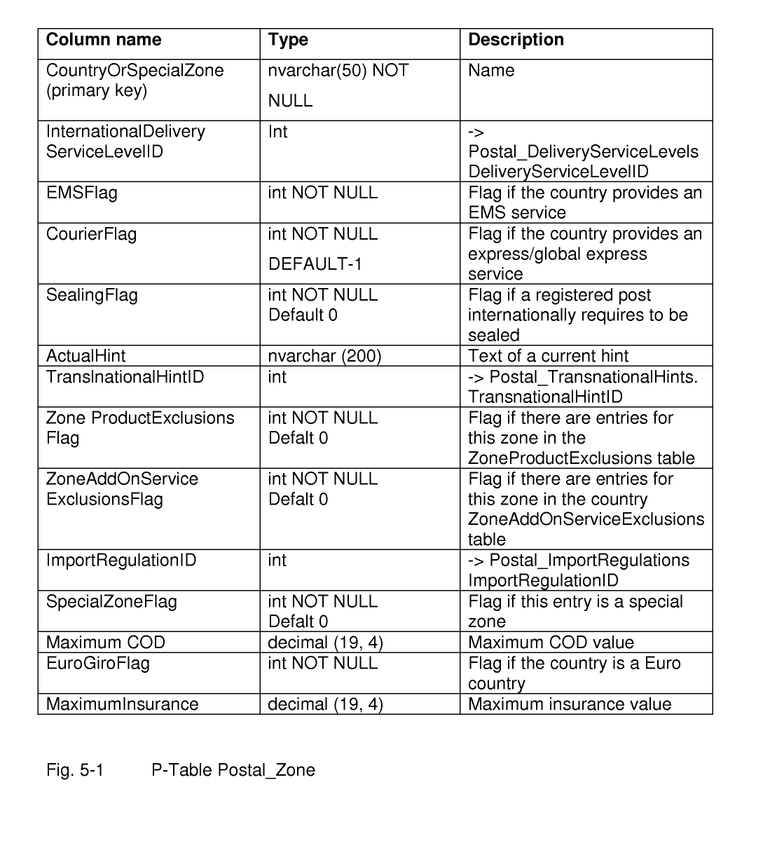

FIG. 5 defines one of the main tables (zone) that defines the destination. It should be said that the postal products or additional services are subdivided into countries and special zones (areas within countries). I.e. both countries and additional services (service) can be determined as a function of the area or zone. All countries and special zones are defined by this table.

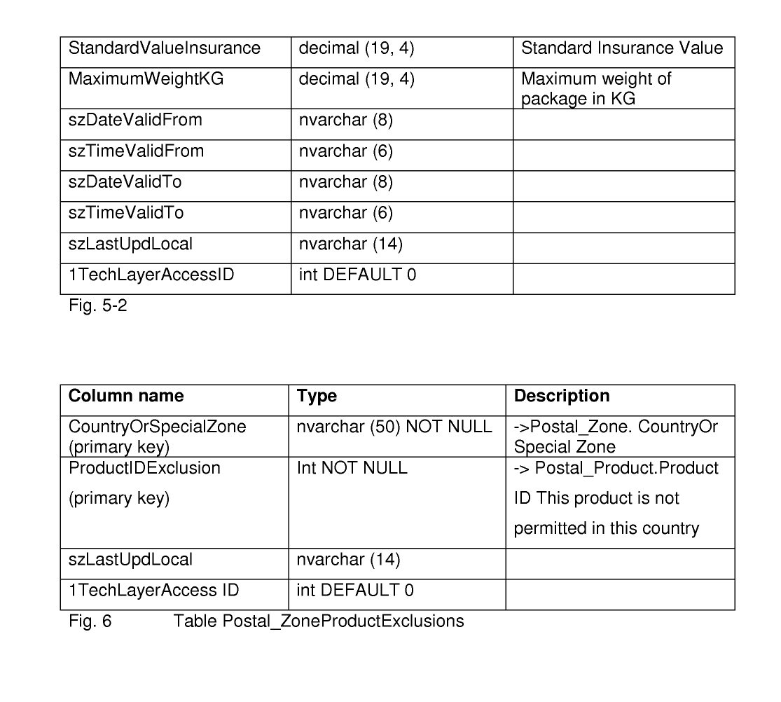

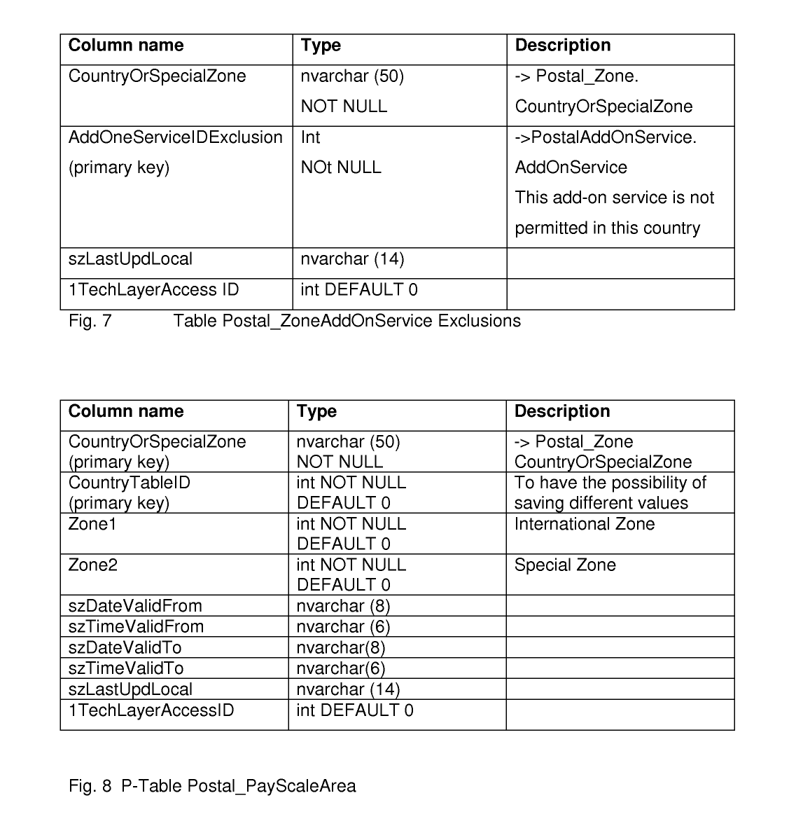

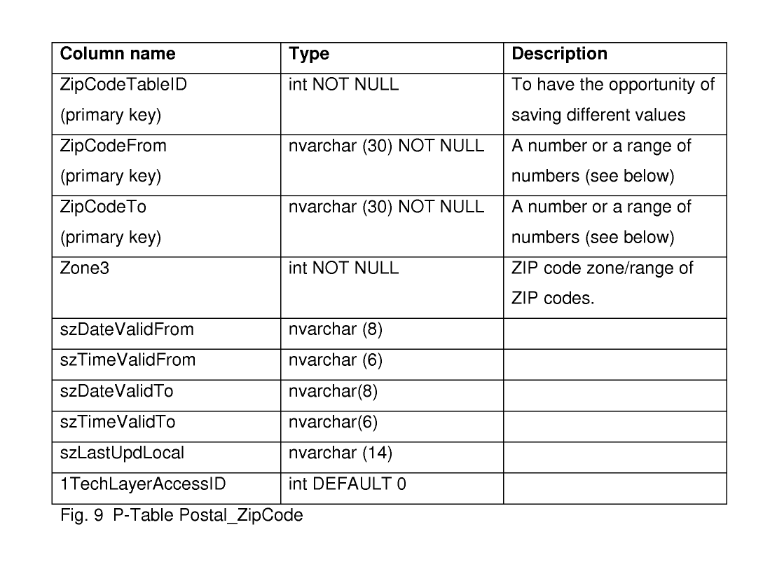

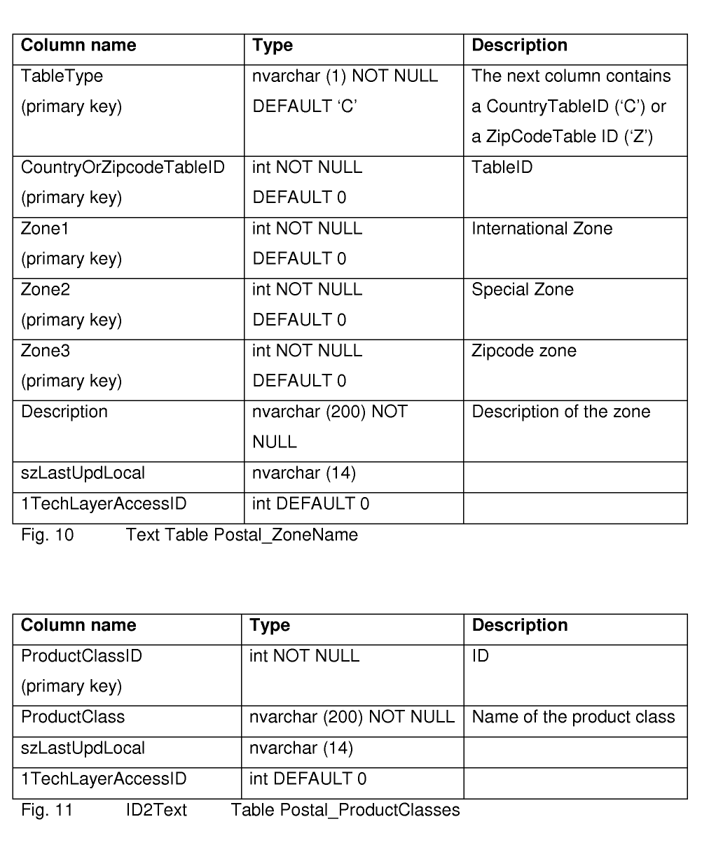

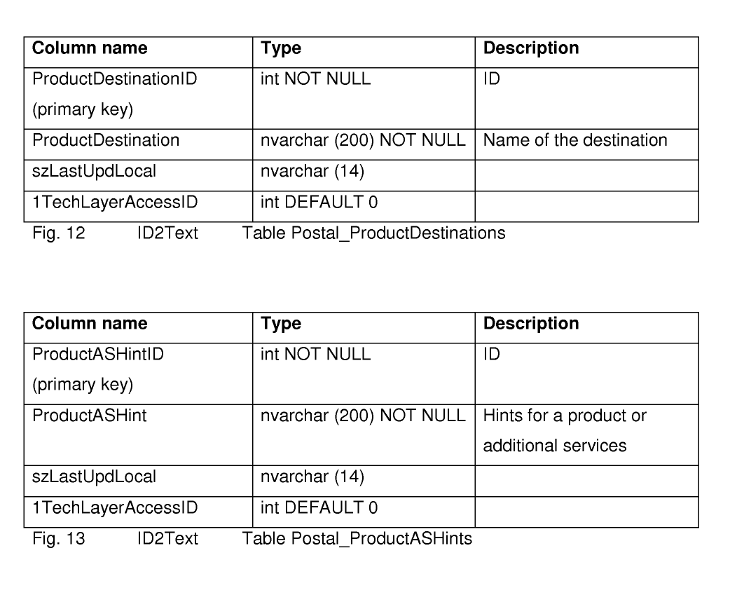

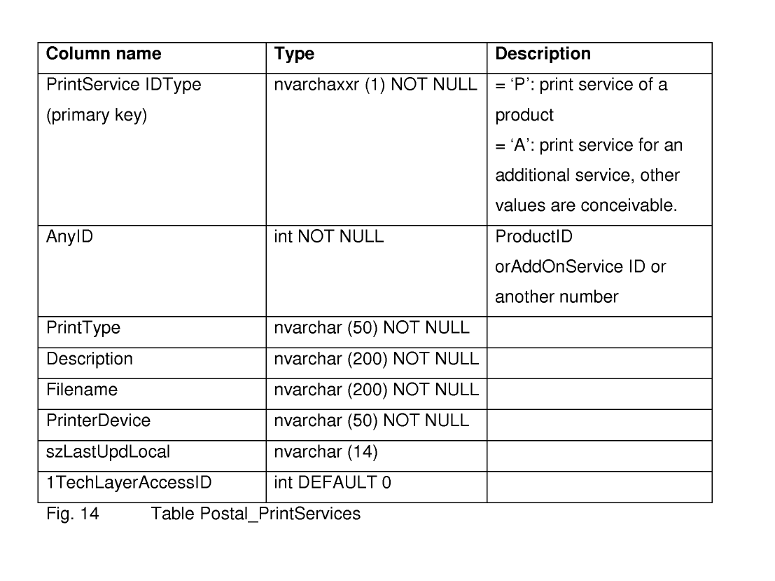

FIG. 6 lists the products that cannot be used in a particular zone. Table 7 lists the additional service that cannot be provided in a particular zone. In both cases, it is exclusionary information for the corresponding products.

In FIG. 8, three different integer values are selected for the Postal_PayScaleArea for “zone”:

Zone1 is the “international” integer value

Zone2 is the “special zone” integer value

Zone3 is the “ZIP code” integer value

Every CountryOrSpecialZone that is defined in the Postal_Zone table should have an entry in the CountryTableID.

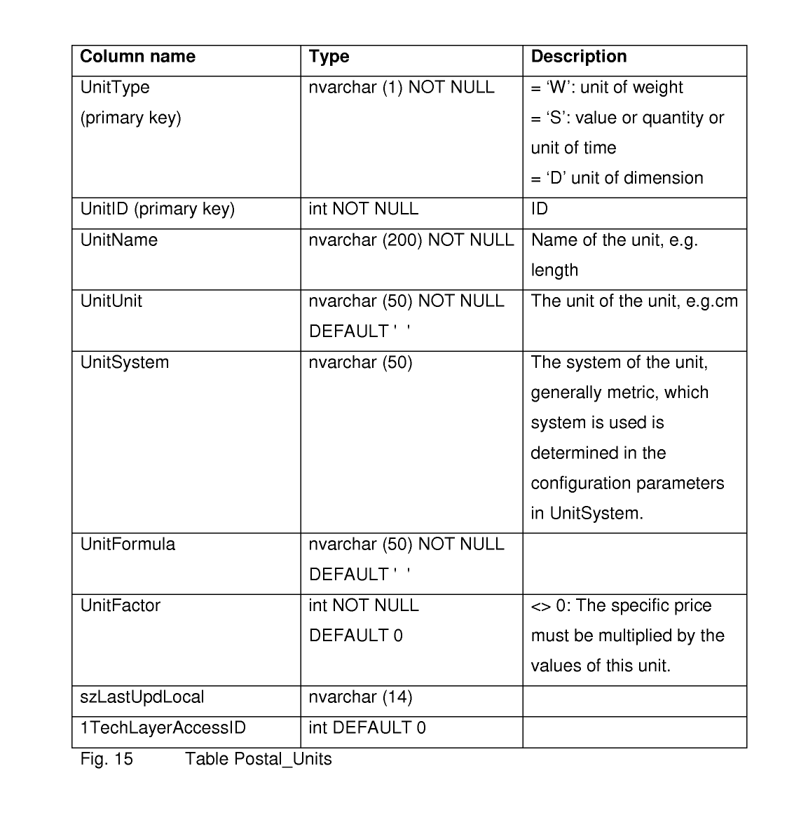

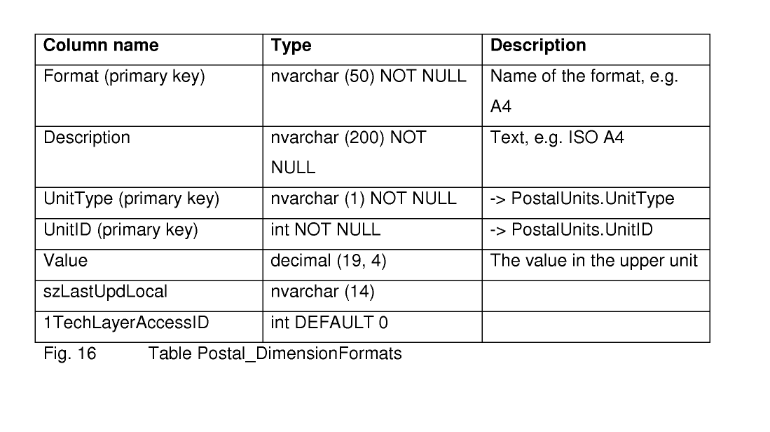

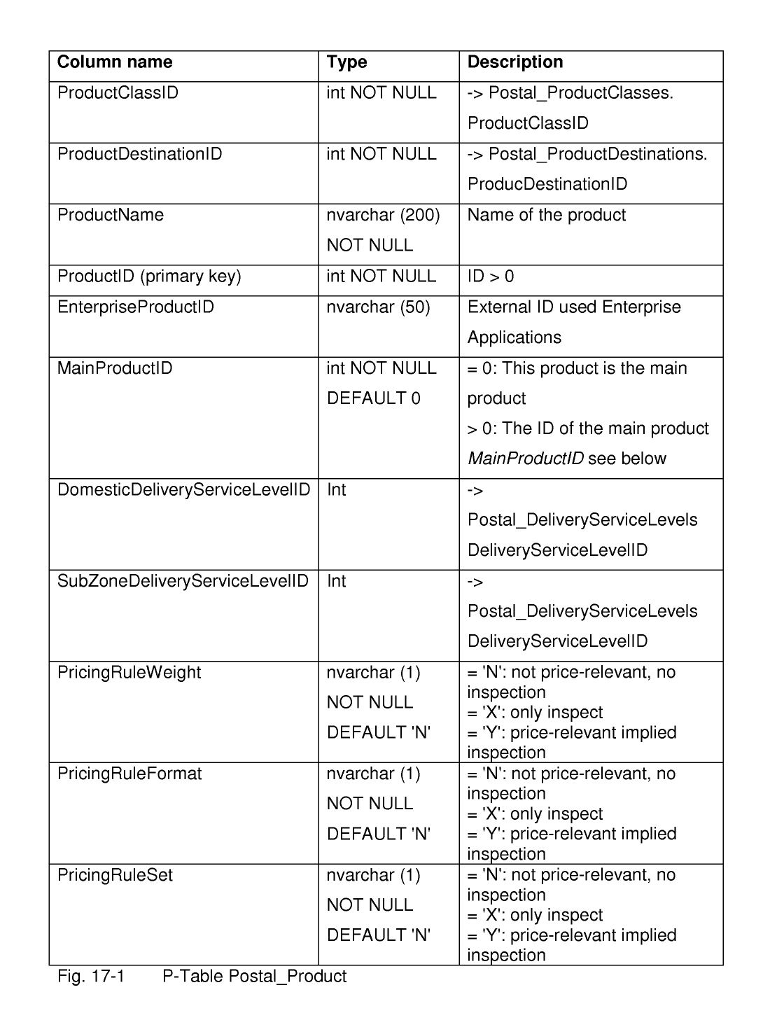

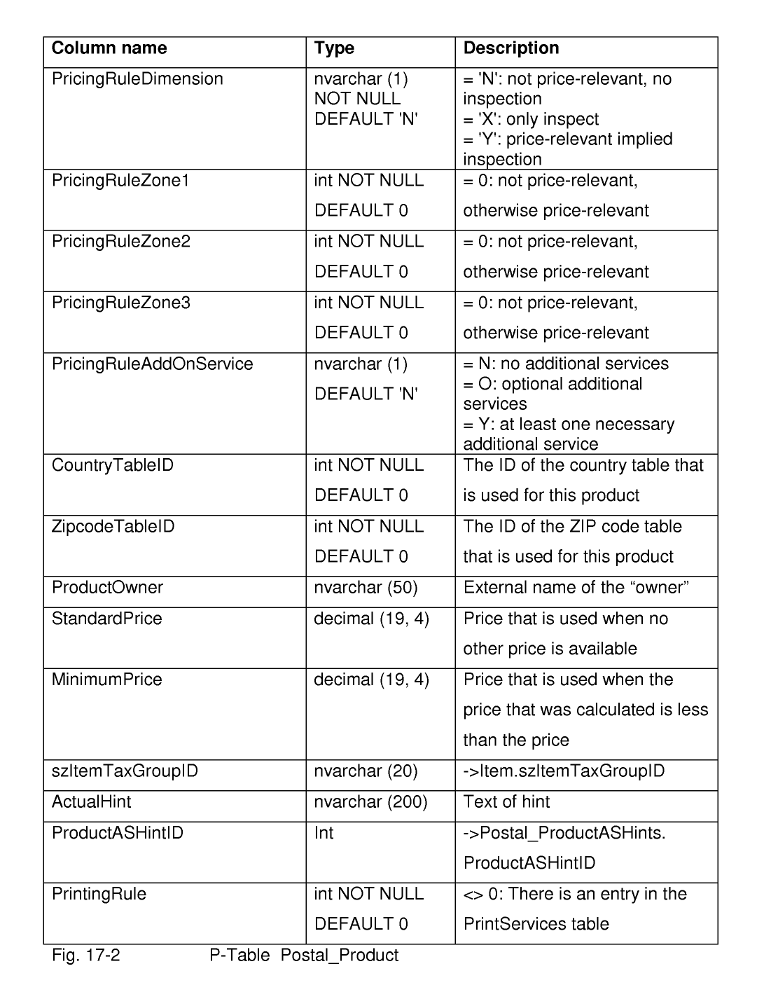

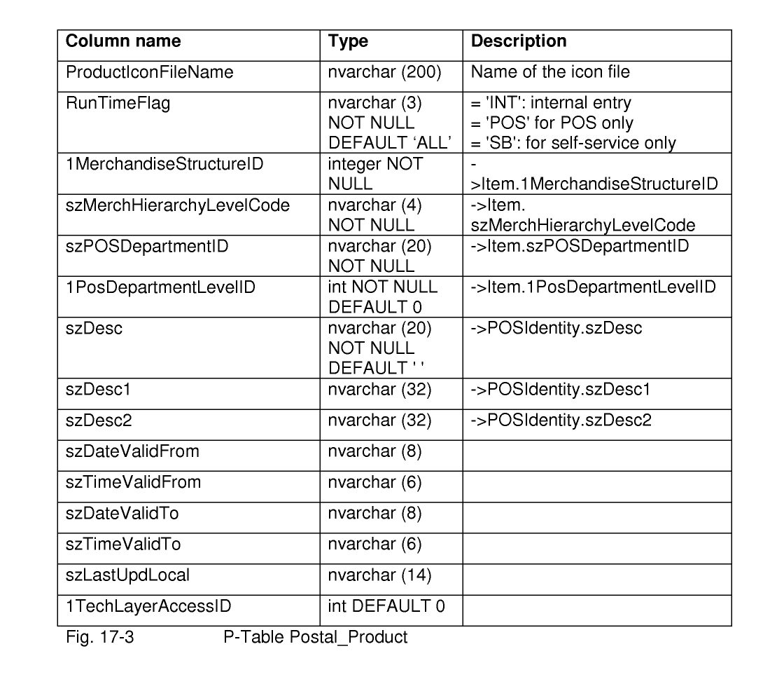

The table in FIG. 15 defines the units of measure that were used in the data model. The UnitFormula field in particular allows the user or operator to store a formula for calculation that determines a unit. The formula normally uses values that were previously entered. A previously entered value is defined in the formula by UnitType and UnitID. This formula is interpreted at runtime.

One could take as an example:

The customer enters the following values:

‘D’ unit 10 “length” in “cm”

‘D’ unit 3 “diameter” in “cm”

‘W’ unit 2 “weight” in “kg”

Then the formula calculates

D10>120 or D3>15 or W2>5

Where the value can be 0 or 1. It should be noted that both logical and arithmetic operations are permitted in the formulas.

The following samples of formulas are permitted U1, U2, . . . Un are units, types plus IDs and V1, V2, . . . Vn are values:

“Normal” expressions in which the following operators are used +−*/( )

Example: ((W1-20)*0.00352+0.28)*S4

CEILING(U1)

Rule: Parts of the formula between ‘(‘and’)’ must be a unit plus ID. The result is the smallest integer larger than or equal to the value. Numbers are rounded up.

FLOOR (U1)

Rule: is the opposite of CEILING (U1)

MAX (U1, U2, . . . , Un)

Rule: determines the maximum value.

U1>V1 or U2>V2 or . . . Un>Vn

Rule: shows an OR link with an arithmetic equation

The table Postal_Product is described in FIG. 15. This table is the basis for all product definitions. The products are grouped in two ways, first into product classes (letters, packages, etc.) and secondly into product destinations (national or international, etc.). Each product has a ProductID. Additional tables that contain specific definitions for a product also have a ProductID so that a link is possible.

Furthermore a product can be a variation of a primary product. Then the value MainProductID>0. In this data model a product cannot a variant of a variant. This may be possible in other data models.

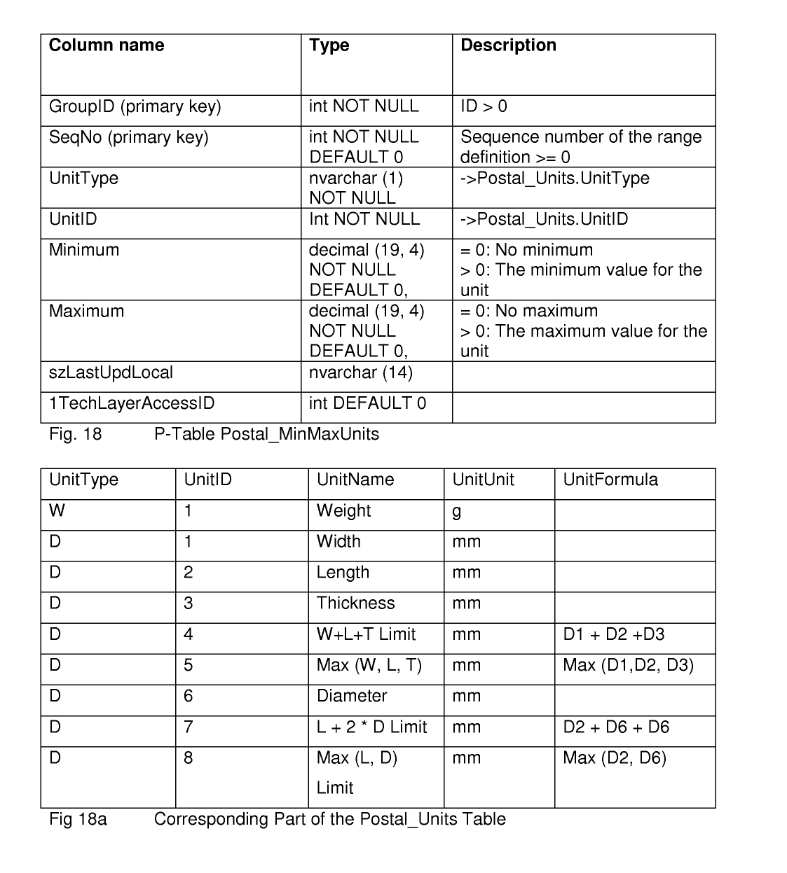

FIG. 18 shows a definition of ranges. A definition of range is made for a minimum and maximum plus the corresponding unit. If the unit is weight in kilos, Min/Max is from 10 to 20 for example. The definitions of ranges are again grouped. Normally for weights there is only one definition of range in a group, but for dimensions definitions can be specified that stand for length, height and depth. A group is identified with a unique GroupID that is defined in the Postal_RatesAndFees table.

Tables 18-18b show possible embodiments of tables with entries.

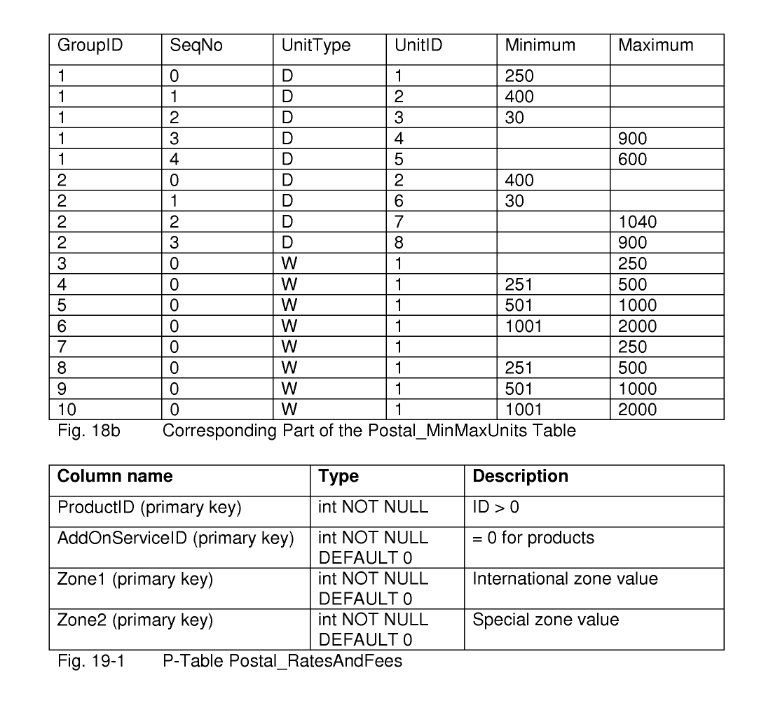

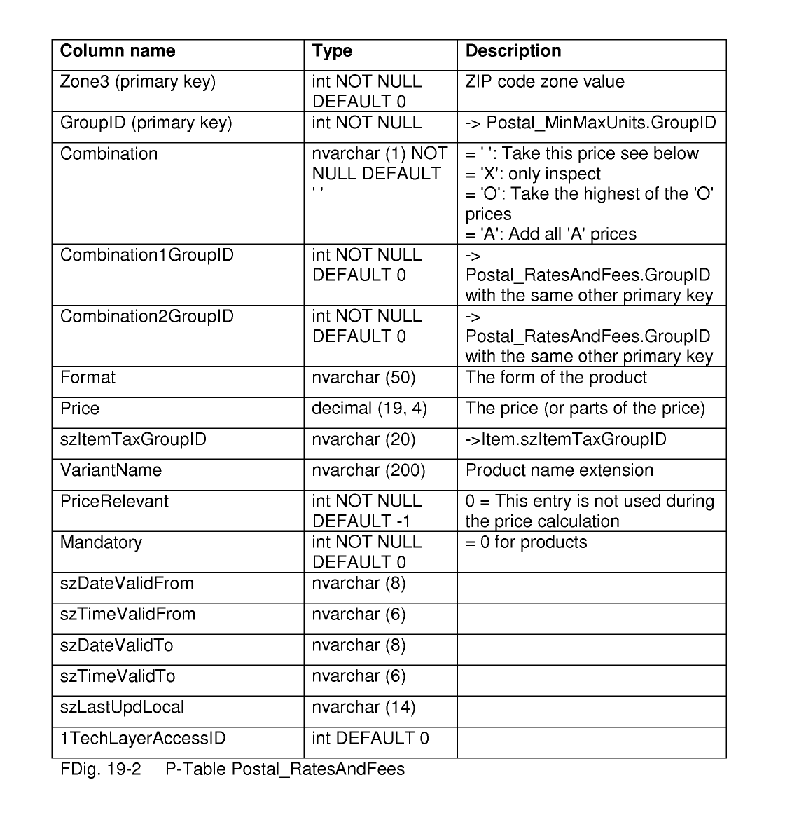

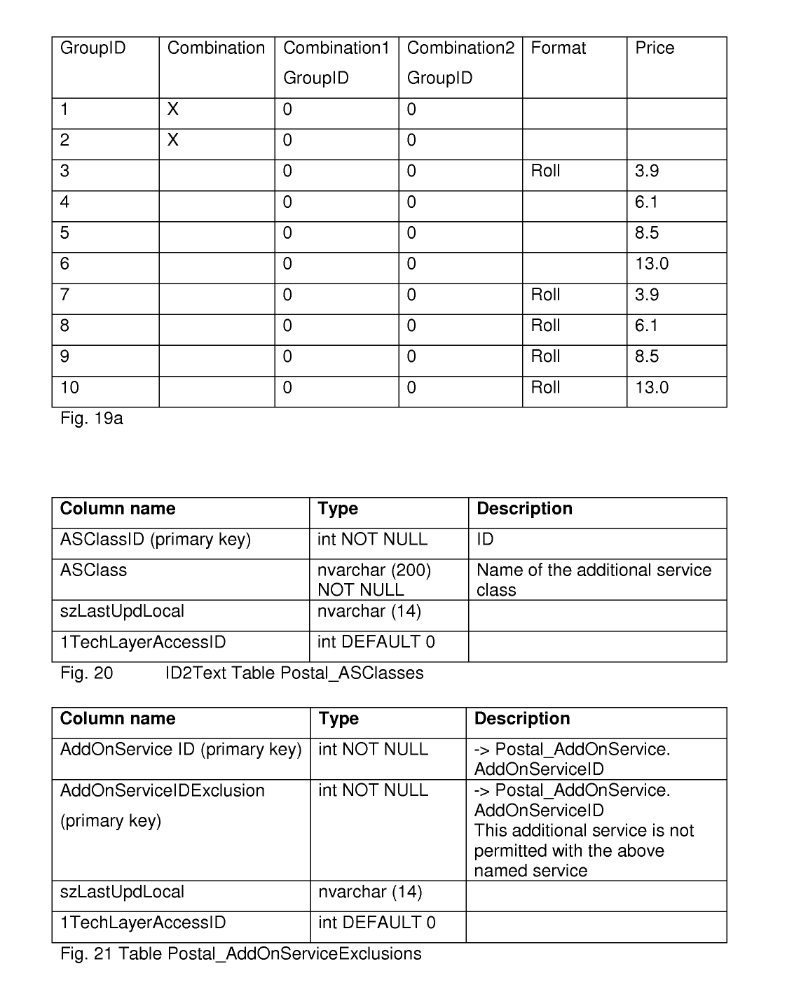

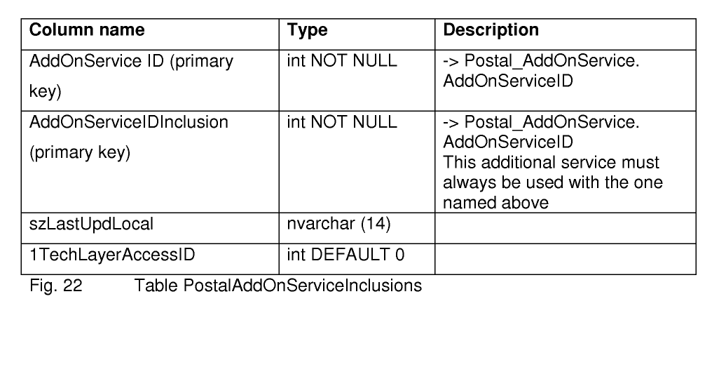

The PostalRatesAndFees table is another important table that is shown as an embodiment in FIG. 19 a and b. This table now contains numbers. This table references the definition of ranges in Postal_MinMaxUnits and contains prices for a product and the three insider values for the zones.

This is the same table as for Postal_RatesAndFees and AddOnService definitions.

With respect to FIG. 19a, some aspects must be noted. If the Combination column is X, the values calculated and entered must fit in the range defined by the GroupID. If the value is empty, the suitable “matching” range defines the price. Thus the continuation for the example of the Postal_MinMaxUnit table looks as it does in FIG. 19a.

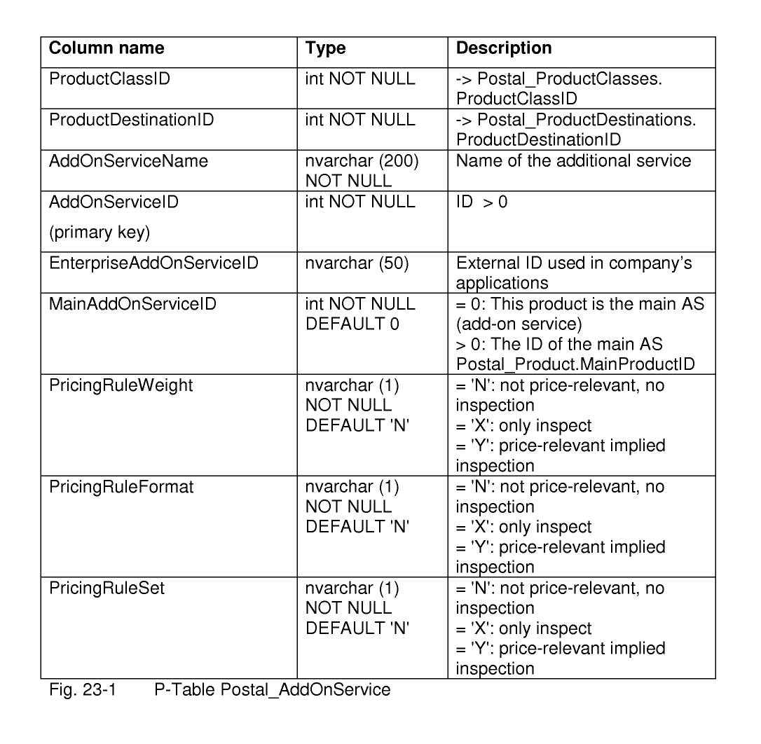

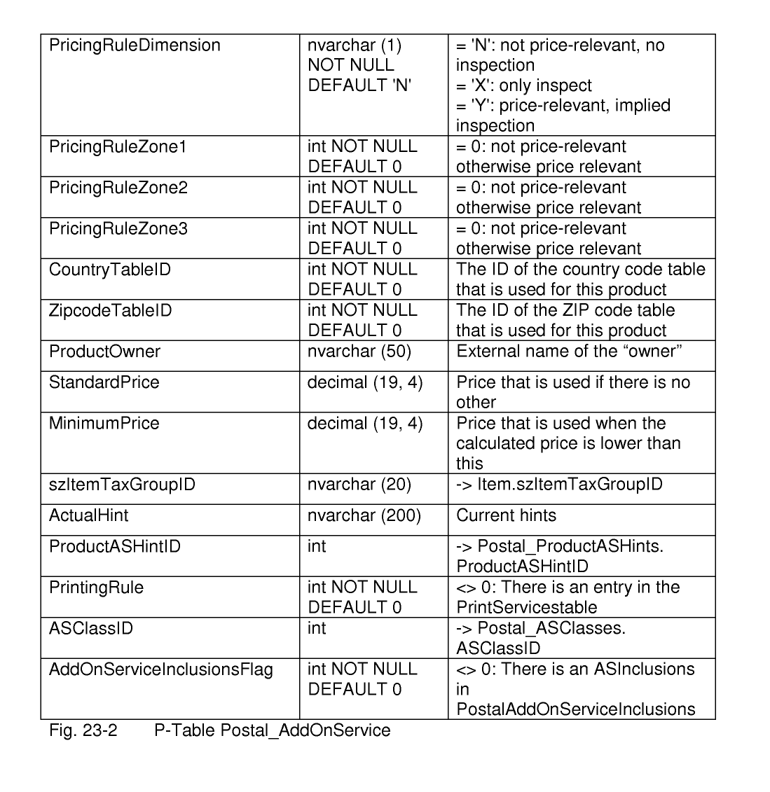

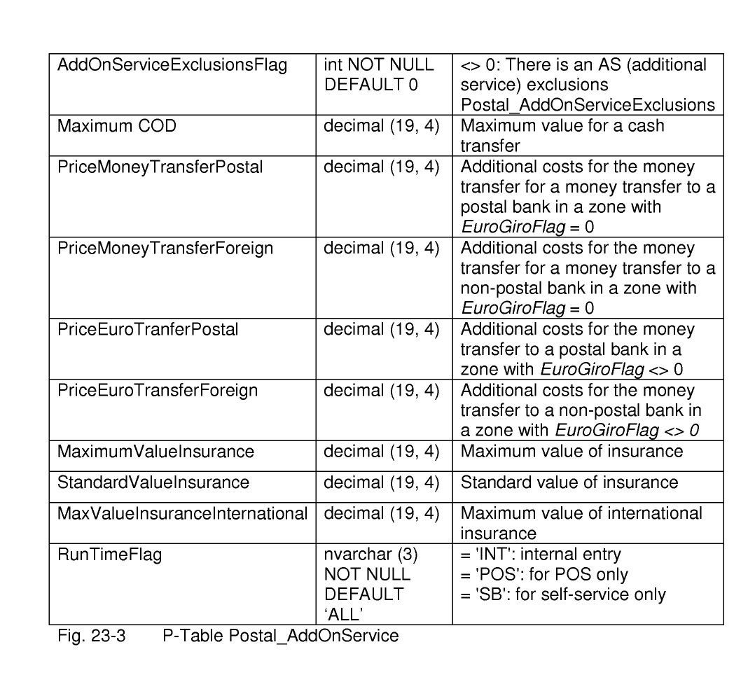

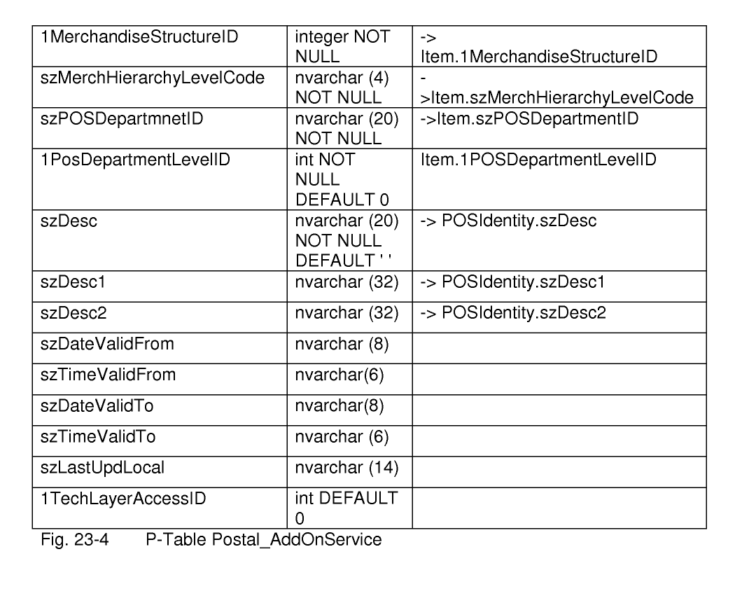

FIG. 23 shows a table with the Postal_AddOnServices. Additional services can belong to one or several products. The result is that the additional services are grouped in the same way products can be, with the additional or added service classes. The link between products and additional services is shown in the Postal_ASRatesAndFees table.

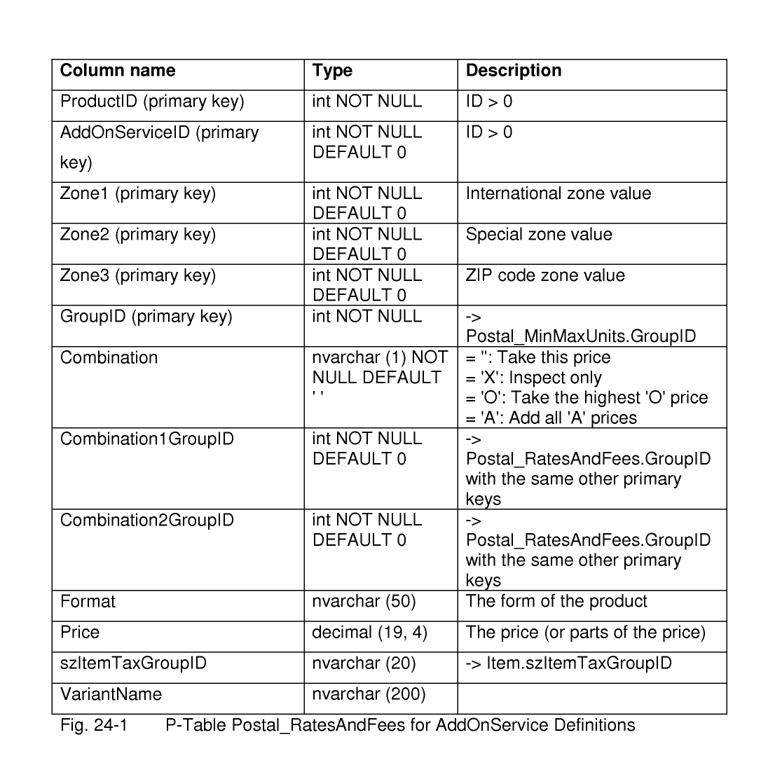

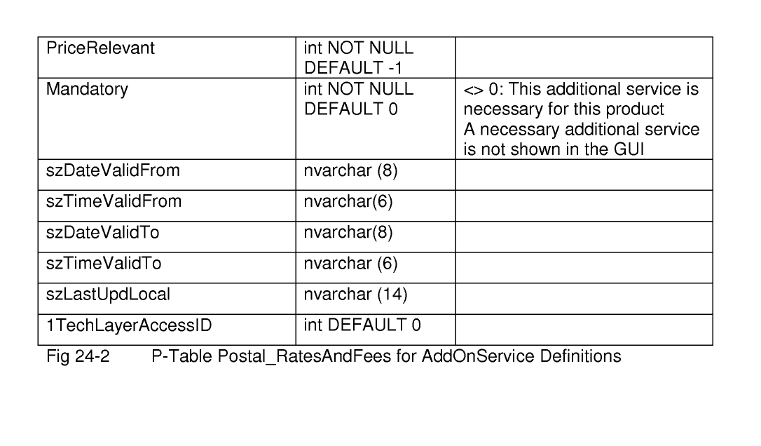

The table in FIG. 24 links the products with additional services. It contains definitions of ranges and prices for each combination and three integer values for the zones. This table references the range definition in Postal_MinMaxUnits. This is the same table as the Postal_RatesAndFees for product definitions. There are two columns that are used only for products: VariantName and PriceRelevant. These values are not used for AddOnServices.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

1. A system for the variable depiction of postal services for postal products comprising:
a processor for performing calculations and interpreting formulas at run time
having a database system consisting of a memory system that can read and write data provided with a format to save tables comprising
a) a table for the destination in which the possible destinations for the postal product are stored;
b) a table for the postal product in which the possible types of postal product are stored;
c) a table for additional services in which the type of transport of the postal product is stored where these tables are linked,
d) a table with price information, where the tables a)-d) are linked directly or indirectly by additional tables, where at least one database system is provided in which formula are stored that can be changed by a user and which are interpreted by the processor at runtime to calculate the price
having a network interface to allow communication with clients over a network, wherein inquiries about pricing for postal products are received over the interface and which makes it possible to receive all the necessary information about pricing or only parts in order to enter into a dialog with the client if information is missing.

2. The system from claim 1, comprising a service-oriented architecture (SOA).

3. The system from claim 1, wherein the database has a sub-table that defines added additional services that can be selected in addition to the existing additional services.

4. The system from claim 1, wherein there is a sub-table for the area table that defines exclusions and/or there is a sub-table for the additional services that defines exclusions from the additional services, and/or there is a sub-table that defines minimum and maximum units for the products.

5. The system from claim 1, wherein a unit of a product is defined by a sub-table, the user-defined formulae are saved in the table that preferably take dimensions, weight and/or quantities into account.

6. A method for variably depicting postal services for postal products with a computer system that has a processor to interpret formulae at runtime, having a database system that consists of a memory system that administers digital data that are stored in the form of tables, comprising:
a) a table for the destination in which the possible destinations for the postal product are stored;
b) a table for the postal product in which the possible types of postal product are stored;
c) a table for the additional service in which the type of transport for the postal product is stored, where these tables are linked
d) a table with price information, where tables a)-d) are linked directly or indirectly through additional tables, wherein at least one database field is provided in which formulae are stored that can be changed by a user and that are interpreted at runtime by the processor to calculate the price;
with a network interface to permit communication with clients over a network, comprising the steps:
inquiries about postal product pricing over the network interface, wherein the necessary information about pricing can be determined in a dialog with the client if information is missing, where the missing information can be determined from the content of the database
calculating the price by interpreting the formulae that are stored in the database.

7. The method from claim 6 wherein a service-oriented architecture (SOA) is utilized.

8. The method from claim 6 regarding the method, wherein the database has a sub-table that defines additional added services that are evaluated additionally to the existing additional services.

9. The method from claim 6 wherein there is a sub-table for the Area table that defines area exclusions and/or there is a sub-table for the additional services that defines exclusions from the additional services and/or there is a sub-table that defines minimum and maximum units for the products that are evaluated when scanned.

10. The method from claim 6, wherein a unit of a product is defined by a sub-table, the user-defined formula is saved in the table that preferably takes into account the dimensions, the weight and/or quantities and that is interpreted during runtime.
